(19) United States
(12) Patent Application Publication
(10) Pub. No.: US 2015/0046308 A1
(43) Pub. Date: Feb. 12, 2015

(54) MULTI CURRENCY PRICING AND NETWORK TRANSACTION SERVICES

(71) Applicant: PURE COMMERCE PTY LIMITED, Sidney, New South Wales (AU)

(72) Inventor: Sunil Sharma, Sydney (AU)

(73) Assignee: Pure Commerce Pty Limited, Sydney, New South Wales (AU)

(21) Appl. No.: 14/357,599

(22) PCT Filed: Nov. 12, 2012
(86) PCT No.: PCT/IB2012/002292

§ 371 Date: Oct. 14, 2014

(30) Foreign Application Priority Data
Nov. 10, 2011 (NZ) 596346

(51) Int. Cl. G06Q 40/00

(52) U.S. Cl. CPC G06Q 40/00
USPC 705/35

(57) ABSTRACT

A method of multi-currency pricing over a network, comprising or including the steps of providing information to a first computer device in a first geographic location connected to said network, obtaining identifying data of said first computer device, detecting said first geographic location of said first computer device from said identifying data, choosing a first currency based on said first geographic location, calculating an equivalent in said first currency to at least one price in said information, wherein said information provided to said first computer device is in said first currency, which is the local currency of said first geographic location.

### FIELD OF THE INVENTION

The present invention relates to sale and purchase of goods and services over a network, and systems and methods for altering the currency of the purchase. In particular, though not solely, the present invention is directed to allowing this sale and purchase to occur in a default currency, or any one of a number of currencies chosen by the purchaser or set from the purchaser's location.

### BACKGROUND OF THE INVENTION

When purchasing goods and services over a network, for example but not limited to, the internet, a purchaser may want to pay in currency different to the server location, or network, the goods and services are offered on.

For example a purchaser of goods located in Australia may want to pay Australian dollars for products offered from a website that is located in Europe. Alternatively the purchaser may wish to elect a currency that is different to that of their home location or the server or network location.

Historically this option was not available and the user had to pay for the goods or service in one set currency (typically US dollars, or Euros or Pounds Sterling) and then wait for processing of their payment and the currency exchange rate at the time to see what the actual local currency price turned out to be. This also exposed them to currency fluctuations from when they purchase their goods to when the purchase is processed.

Multi-Currency Pricing (MCP) is defined to be a financial service which allows businesses to price goods and services in a variety of foreign currencies, while continuing to receive settlement and reporting in their home currency. With MCP, merchants can sell the same item to US customers in US Dollars, French customers in Euros, and Japanese customers in Japanese Yen. Thus MCP allows cardholders to shop, view prices and pay in the currency of their choice while merchants receive their settlements in their accounting currency.

Traditionally this was a complex process, and merchants only had the ability to price their goods in a handful of currencies. In the Internet age, ecommerce merchants can price their wares in a range of currencies, can receive and update multi-currency pricing information in real time, and the clients have the ability to make a choice with relative ease.

More advanced solutions have since become available. Now purchasers have the ability to manually choose a currency once they have gone to the website, server or network. A user may not see they have this choice and thus be deterred from purchasing. Even if they do see this choice then having to do this manually may still deter a purchaser from using the site.

One example of such choosing is shown in publication WO 2001/77916. Here a user is presented with a screen, when they first go to a website, where they can choose either their country of origin, or their preferred country. Thereafter the currency and language of the country are utilised. Also where the particular law of that country requires or prevents certain things then this also is reflected in the website. For example is certain goods are illegal in the chosen country then the user would be prevented from purchasing them. Also if there are certain consumer protection laws then these can be reflected in the terms of trade for that transaction.

There are other ways in which a purchaser's location and thus currency can be identified. For example the Payment Card Number can be employed for example, such as is used for Point of Sale terminal currency conversion. However this method requires insertion of the card number and therefore further waiting.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is therefore an object of the present invention to provide an improved multi-currency pricing and network transaction service, or to overcome the above shortcomings or address the above desiderata, or to at least provide the public with a useful choice.

### SUMMARY OF THE INVENTION

In a first aspect the present invention consists in a method of multi-currency pricing over a network, comprising or including the steps of providing information to a first computer device in a first geographic location connected to said network, obtaining identifying data of said first computer device, detecting said first geographic location of said first computer device from said identifying data, choosing a first currency based on said first geographic location, calculating an equivalent in said first currency to at least one price in said information, wherein said information provided to said first computer device is in said first currency, which is the local currency of said first geographic location.

Preferably said identifying data is any one or more of the following, a internet protocol address, latitude and longitude, global Positioning System coordinates, and equivalents.

Preferably said information includes at least one product or service for sale for said price.

Preferably said information is provided over said network from a second said computer device in at least one second said geographic location.

Preferably said first computer device or a user thereof can override said first currency and set it to a second currency of their choosing.

Preferably said first currency is the same as said second currency when said first geographic location and said second geographic location are the same.

Preferably said first computer device or a user thereof purchases said at least one product or service in said first or second currency (“session currency”).

Preferably said first computer device or user thereof is billed in said session currency for said purchase.

Preferably said second computer device enables payment of a seller or merchant of said at least one product or service in a third currency.

Preferably said payment in said third currency is based on an equivalent to said price in said third currency.

Preferably said third currency is based on a location of said seller or merchant or is a chosen currency of said seller or merchant.

Preferably said step of detecting said first geographic location involves decoding, reverse coding, matching or looking up said identifying data in a database to obtain said first geographic location.

Preferably said identifying data is said Global Positioning System coordinates or said Latitude and longitude, these are reverse geocoded to obtain said first geographic location.

Preferably said step of choosing said first currency involves looking up the local currency of said first geographic location.

Preferably said steps of calculating an equivalent to said price involve looking up the exchange rate for that currency.

In another aspect the present invention consists in a computer implemented method of multi-currency pricing over a network, comprising or including the steps of providing information to a first computer device in a first geographic location connected to said network, obtaining identifying data of said first computer device, detecting said first geographic location of said first computer device from said identifying data, choosing a first currency based on said first geographic location, calculating an equivalent to said price in said first currency, wherein said information provided to said first computer device is in said first currency, which is the local currency of said first geographic location.

In another aspect the present invention consists in a computer operated program adapted to run on a second computer device connected to a network, comprising or including the steps of providing information to a first computer device in a first geographic location connected to said network, obtaining identifying data of said first computer device, detecting said first geographic location of said first computer device from said identifying data, choosing a first currency based on said first geographic location, calculating an equivalent in said first currency to at least one price in said information, wherein said information provided to said first computer device is in said first currency, which is the local currency of said first geographic location.

In another aspect the present invention consists in a computer device, said computer device (“second computer device”) operatively connected to a network and located in a second geographic location, to carry out the following steps, providing information to a first computer device in a first geographic location connected to said network, obtaining identifying data of said first computer device, detecting said first geographic location of said first computer device from said identifying data, choosing a first currency based on said first geographic location, calculating an equivalent in said first currency to at least one price in said information, wherein said information provided to said first computer device is in said first currency, which is the local currency of said first geographic location.

In another aspect the present invention consists in a system for multi-currency pricing, adapted to run on a second computer device operatively connected to a network and located in a second geographic location, to carry out the following steps, providing information to a first computer device in a first geographic location connected to said network, obtaining identifying data of said first computer device, detecting said first geographic location of said first computer device from said identifying data, choosing a first currency based on said first geographic location, calculating an equivalent in said first currency to at least one price in said information, wherein said information provided to said first computer device is in said first currency, which is the local currency of said first geographic location.

In another aspect the present invention consists in a method of multi-currency pricing over a network, comprising or including the steps of, providing information to a first computer device in a first geographic location connected to said network, obtaining an internet protocol address (or equivalent) of said first computer device, detecting said first geographic location of said first computer device from said internet protocol address (or equivalent), choosing a first currency based on said first geographic location, calculating an equivalent in said first currency to at least one price in said information, wherein said information provided to said first computer device is in said first currency, which is the local currency of said first geographic location.

Preferably said information includes at least one product or service for sale for said price.

Preferably said information is provided over said network from a second said computer device in at least one second said location.

Preferably said first currency is the same as said second currency when said first geographic location and said second location are the same.

Preferably said locations are countries.

Preferably said first computer device or a user thereof can override said first currency and set it to a second currency of their choosing.

Preferably said first computer device or a user thereof purchases said at least one product or service in said first or second currency (“session currency”).

Preferably said first computer device or user thereof is billed in said session currency for said purchase.

Preferably said second computer device enables payment of a seller or merchant of said at least one product or service in a third currency.

Preferably said payment in said third currency is based on an equivalent to said price in said third currency.

Preferably said third currency is based on a location of said seller or merchant or is a chosen currency of said seller or merchant.

Preferably said step of detecting said first geographic location involves looking up said internet protocol address (or equivalent) in an internet protocol address (or equivalent) database to obtain said first geographic location.

Preferably said step of choosing said first currency involves looking up the local currency of said first geographic location.

Preferably said steps of calculating an equivalent to said price involve looking up the exchange rate for that currency.

In another aspect the present invention consists in a computer implemented method of multi-currency pricing over a network, comprising or including the steps of providing information to a first computer device in a first geographic location connected to said network, obtaining an internet protocol address (or equivalent) of said first computer device, detecting said first geographic location of said first computer device from said internet protocol address (or equivalent), choosing a first currency based on said first geographic location, calculating an equivalent to said price in said first currency, wherein said information provided to said first computer device is in said first currency, which is the local currency of said first geographic location.

In another aspect still the present invention consists in a computer operated program adapted to run on a second computer device connected to a network, comprising or including the steps of providing information to a first computer device in a first geographic location connected to said network, obtaining an internet protocol address (or equivalent) of said first computer device, detecting said first geographic location of said first computer device from said internet protocol address (or equivalent), choosing a first currency based on said first geographic location, calculating an equivalent in said first currency to at least one price in said information, wherein said information provided to said first computer device is in said first currency, which is the local currency of said first geographic location.

In yet another aspect the present invention consists in a computer device, said computer device (“second computer device”) operatively connected to a network and located in a second location, to carry out the following steps, providing information to a first computer device in a first geographic location connected to said network, obtaining an internet protocol address (or equivalent) of said first computer device, detecting said first geographic location of said first computer device from said internet protocol address (or equivalent), choosing a first currency based on said first geographic location, calculating an equivalent in said first currency to at least one price in said information, wherein said information provided to said first computer device is in said first currency, which is the local currency of said first geographic location.

In yet another aspect yet again the present invention consists in a system for multi-currency pricing, adapted to run on a second computer device operatively connected to a network and located in a second location, to carry out the following steps, providing information to a first computer device in a first geographic location connected to said network, obtaining an internet protocol address (or equivalent) of said first computer device, detecting said first geographic location of said first computer device from said internet protocol address (or equivalent), choosing a first currency based on said first geographic location, calculating an equivalent in said first currency to at least one price in said information, wherein said information provided to said first computer device is in said first currency, which is the local currency of said first geographic location.

In yet another aspect still the present invention consists in a method of multi-currency pricing over a network as herein described with reference to any one or more of the accompanying drawings.

In yet another aspect still the present invention consists in a computer implemented method of multi-currency pricing over a network as herein described with reference to any one or more of the accompanying drawings.

In yet another aspect the present invention consists in a computer operated program as herein described with reference to any one or more of the accompanying drawings.

In yet another aspect the present invention consists in a computer device as herein described with reference to any one or more of the accompanying drawings.

In yet another aspect the present invention consists in a system for multi-currency pricing as herein described with reference to any one or more of the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present, but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

To those skilled in the art to which the invention relates, many changes in construction and widely differing embodiments and application of the invention will suggest themselves without departing from the scope of the invention as defined in the appended claims. The disclosures and the descriptions herein are purely illustrative and are not intended to be in any sense limiting.

Other aspects of the invention may become apparent from the following description which is given by way of example only and with reference to the accompanying drawings.

### BRIEF DESCRIPTION OF THE DRAWINGS

Preferred forms of the present invention will now be described with reference to the accompanying drawings in which;

FIG. 1: illustrates shows a flow chart of one preferred method of the present invention,

FIG. 2: shows an illustrative example of screen shot showing a drop down window showing the location based session currency in Australia as AUD, whereby the drop down window allows for over-riding of the location based session currency,

FIG. 3: shows an illustrative example of a screen shot showing the resulting purchase offer to a user, in this case for hotel rooms with the session currency location in AUD,

FIG. 4: shows an illustrative example of a screen shot showing the resulting payment method, in this case by credit card showing the user's location as Australia,

FIG. 5: shows a further illustrative example of screen shot showing a drop down window showing the location based session currency in Japan as Yen, whereby the drop down window allows for over-riding of the location based session currency,

FIG. 6: shows a further illustrative example of a screen shot showing the resulting purchase offer to a user, in this case for hotel rooms with the session currency location in Yen,

FIG. 7: shows an illustrative example of a screen shot showing the resulting payment method, in this case by credit card showing the user's location as Japan,

FIG. 8: illustrates shows a further flow chart of a preferred method of the present invention, and

FIG. 9: is a flow chart showing the workflow inside the Foreign Exchange Server of FIG. 8.

### DETAILED DESCRIPTION OF THE PREFERRED EMBODIMENT

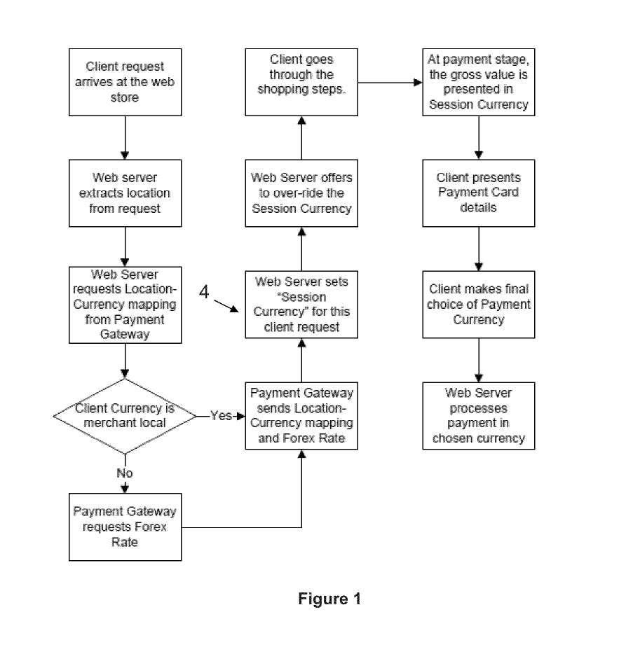

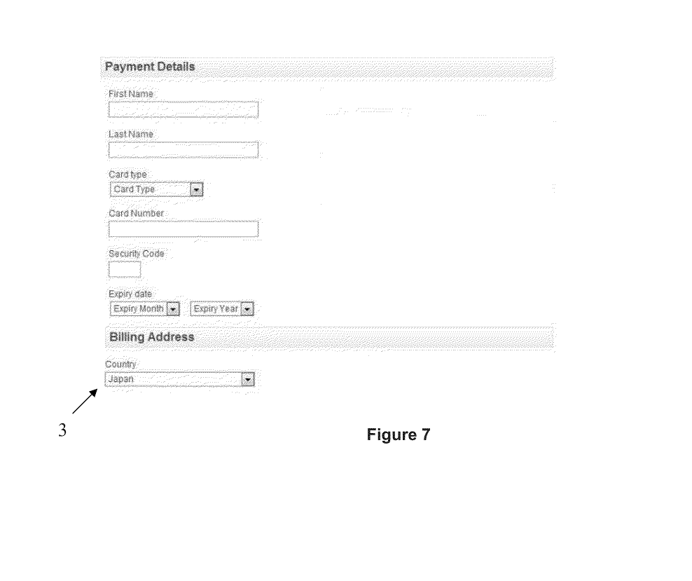

Preferred embodiments will now be described with reference to FIGS. 1 through 9.

Location based multi-currency pricing (“MCP”), shown in FIG. 1, refers to the situation in which the preferred currency (session currency) for a transaction is determined on the basis of the geographic location of the client, that is, the (first) computer device itself the user is on and its geographic location (first geographic location) (3). The location is made found using identifying data of the device. The device may be a computer, laptop, or smart device such as a phone, tablet or similar.

The identifying data of the device of a user, for example an Internet Shopper, can be of a variety of types. One convenient choice is using the IP address of the client/shopper. The first geographic location (3) is determined from the users IP address (or equivalent identifier) employing a special technique called geographic location identification.

With Internet Protocol (“IP”) addresses, as an example, the user/client IP information is present in every IP packet (“Source IP address”), from the first handshake packet to the last goodbye packet. The server has to extract this information from the packet and keep it handy for sending the response packet back (where this IP address becomes “Destination IP address”). This occurs within the operating system of the computer device. Applications running on the computer applications then ask for it from the operating system whenever it is required. Therefore in most situations no permission to obtain the source IP address is required.

An alternative approach would be to use client's geographical co-ordinates rather than the IP address. Geographical location of the cellular wireless network devices like mobile phones or tablets can be established using geocoding technology. Applications sitting on a mobile device can be enabled to receive the geographical co-ordinates of the device, and this information can be passed to the ecommerce server application where it is used to establish the location (Reverse-Geocoding), and probable native currency of the user.

There are also other possibilities for identifying data. In this document reference to location means that geographic location determined from identifying data, such as but not limited to IP address of the user's device, or geographical co-ordinates of the user's device or any other information that can be used to establish the physical location of the client.

In a typical implementation, the merchant ecommerce application runs on a server or similar (second computer device (10)), this is located at a second location or locations. The second location(s) could be the same country as the first geographic location (3), but often due to the extent and speed of the network will be different. The second computer device (10) as a server is enabled to identify the client location (3) from the identifying data, for example its source identifying data such as IP address, of from reverse geocoding, when the communication starts between the two applications (that is on the user's computer device (2) and the server (10)) and on that basis sets the Session Currency (4) for that client. Session Currency refers to the currency identified as belonging to the physical geographic location (3) from where the client is found to access the ecommerce application. Thus if the client is identified to be located in Sydney in Australia, the Session Currency (4) is set to Australian Dollars or AU$, likewise if the client is identified to be located in Osaka, the Session Currency (4) is set to Japanese Yen, or JPY.

To guard against the possibility the geographic location may have been misidentified, the client is offered the opportunity to over-ride the identifying data currency determination by presenting him or her with a choice of different payment currencies, and a new overriding Session Currency (6) (also referred to as a third currency) may be set depending on the choice made by the client.

There is also a possibility the geographic location is identified correctly, but the client may still want to over-ride the automatic currency determination because he may be a temporary visitor in that location, and would probably want to process the transaction in his/her native currency. This possibility too can be enabled.

Once the client has made his/her choice of session currency (4) or (6), all the prices for this client session are displayed in terms of the Session Currency. Once the client has completed the shopping steps and is ready to pay, the gross value of the transaction is displayed in terms of Session Currency. At this point, he/she is walked through the usual step of inserting payment card details, and finally the payment is processed in the Session Currency. This description is captured in FIG. 1.

Several variations to the above description of the process can arise and will become apparent to a person skilled in the art based on this description, some of them are noted below. It should be noted that these variations relate to implementation details and don't alter the essence of the process in any significant way. Implementation details do need to vary from one implementation to another due to variations in the organization and capability of different contracting parties in this process. The invention offers the location identification and conversion service along with both gateway services and forex rate management and treasury services, exactly which service components will be picked up and how they will be deployed would vary across implementations.

With regards to the Server Architecture, nothing changes within the ecommerce application or the MCP enabled ecommerce Server except in so far as it needs access to a location to Currency conversion mechanism to then be able to display the session currency and rates appropriate to the geographic location. The identifying data of geographic location to Currency conversion is based on Geographic location Technology. For example when IP address based locations is used then compilations of IP to geographic locations are compiled as a database, sometimes by third parties. Since new IP allocations are made all the time, and existing allocations change, the database is updated regularly. IP address and geographic location matchings are held in these geographic location databases. Such databases are available on a subscription basis. Once the geographic location database is procured, it can be installed on the ecommerce server itself, or could become part of the Foreign Exchange Rate Service driven by a standalone Foreign Exchange Rate Server, or the Payment Gateway itself.

When using geographic co-ordinates as the identifying data, for example latitude and longitude, or GPS data then implementation of, or communication with, a reverse geocoding service is needed.

The second computer device (10) (for example a web server) itself could be enabled to run the geographic location identification step, and possibly display purchase value in foreign currency using locally cached forex rate information. That is the second computer device (10) could also contain the forex server (12) and geographic location server (13). This step may or may not require the geographic location database.

The geographic location identification step could be run on the forex server (12) rather than through the payment gateway (11). In this instance, the web server (10) communicates directly with the forex server (12) through all the steps described above except the last one wherein it routes the payment information to the payment gateway (11).

The forex server (12) and payment gateway (11) could be combined together into one service and offered from a single host.

One feature of the present invention is the ability to combine both the payment gateway (11) and the forex server (12).

Referring to FIG. 9 the first step relates to receiving the MCP transactions from the payment gateway (11). After a payment gateway (11) processes a payment transaction, it forwards this information to the Forex Server (12), including the amount of transaction in the base currency (which is the same as the merchant currency), and the amount of the transaction in the customer currency (as determined from the identifying data, also called transaction currency). Thus if the merchant to whom the ecommerce application belongs is located in Singapore, and the shopper is located in Japan, these values will be respectively in SGD and JPY. MCP transactions with different base currencies and transactions are flowing in to the Forex Server (12) (assuming it is servicing merchants from many countries), and it can aggregate the base currency values for each base currency at any point in time, as in step 2. These aggregates in each currency, adjusted for any deductions or enhancements, indicate the payment liability against each base currency (step 3). Likewise, the invention can compute cash receivable against each currency (the aggregate of values in transaction currencies). These two will almost never match, there is normally a surplus in some currencies and deficit in others, these correspond to the net positions (step 4). A server (or owner) can then trade the excess amounts in a set of currencies against deficiency in a different set of currencies (step 5). The server (or owner) can settle with its Forex trade counter parties as per the trades (step 6), and finally settle with merchants as per the computation in step 3 (step 7).

Examples of the user interface produced by the present invention running behind it are discussed in the following examples to explain the user's interaction with the invention

### Example 1

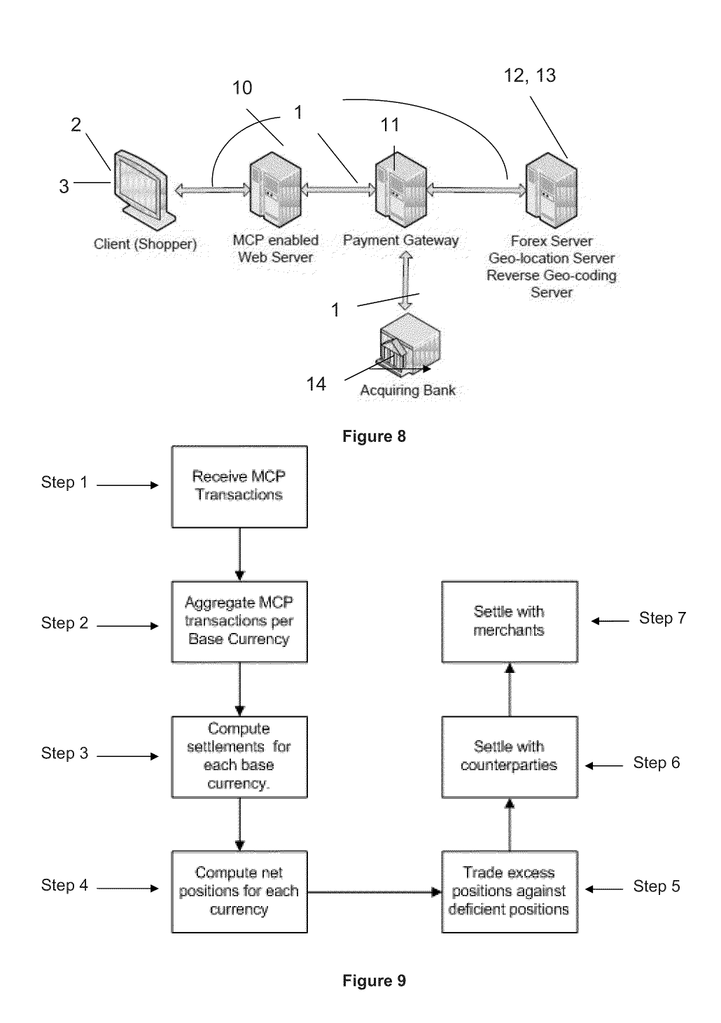

The user accesses the ecommerce application via a first computer device (2) on a network (1) which in turn is connected to at least one second computer device (10), the general architecture of this is shown in FIG. 8.

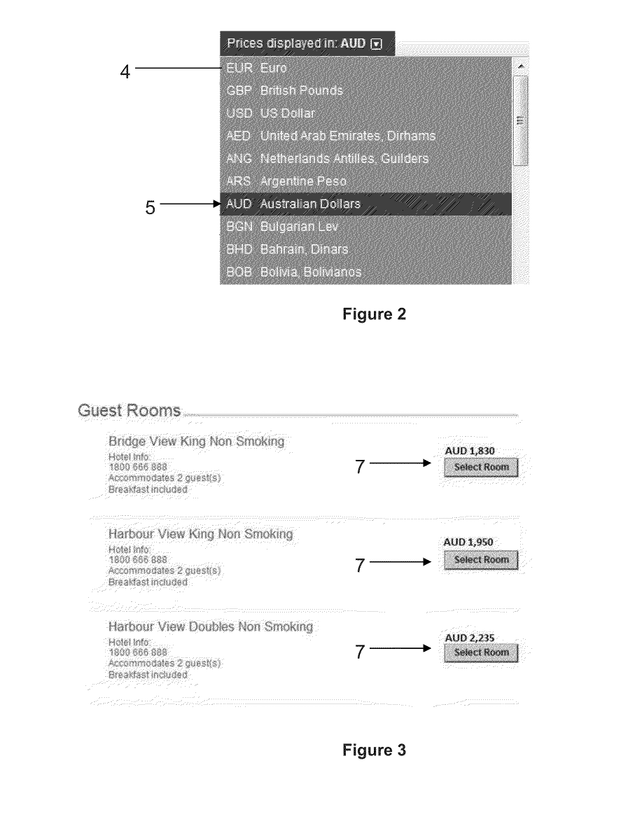

For an illustrative example of this process, consider an ecommerce application located on, or networked to a server (10) that manages the online bookings for a merchant that is a hotel, as shown in FIGS. 2 through 4. When an online shopper accesses this application and its information over the network (1) (for example the internet), the application initially sets the Session Currency (4) (also referred to as the first currency) on the basis of the user's device identifying data and the geographic location identification process as outlined above. The offer to over-ride the automatically set Session Currency (4) may be made at an appropriate location in the application. Typically it will be inserted at a location where any pricing information is initially displayed, or it's about to be displayed with the next click. In our example we assume the latter. Thus for an Australian customer, the choice box as a drop down window (5) of FIG. 2 will be displayed near the point where the client starts exploring the accommodation prices. The default session currency (4) based on location is shown at the top and the drop down window (5) thus allows over-riding of the default location based session currency.

Once this client has confirmed the session currency (either by accepting the default one, or overriding it) they can then insert the initial booking details. For example, when, where and for how long, likely acceptable price ranges, and number of people. Then the ecommerce application may be ready to display the accommodation prices, as in FIG. 3. In this example, we assume that the geographic location was identified correctly, and the client didn't over-ride it.

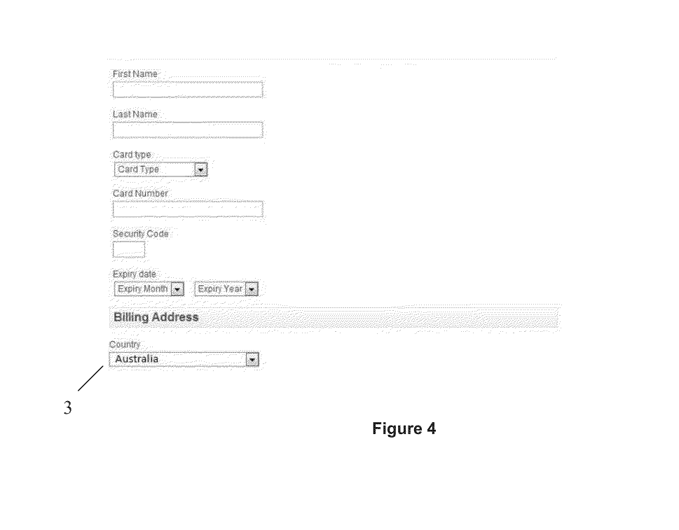

Finally once, the client has made a selection from the available offers (7), he/she may be presented with a payment page that would look include forms for payment card details like in the FIG. 4.

Depending upon the implementation, the currency choice dialog box shown in FIG. 2 may be included here once more if the client had over-ridden the automatically identified payment currency, thus giving her the opportunity to review how the gross value looks in different currencies. Again the first geographic location (3) of the user or first computer device (2) is displayed.

### Example 2

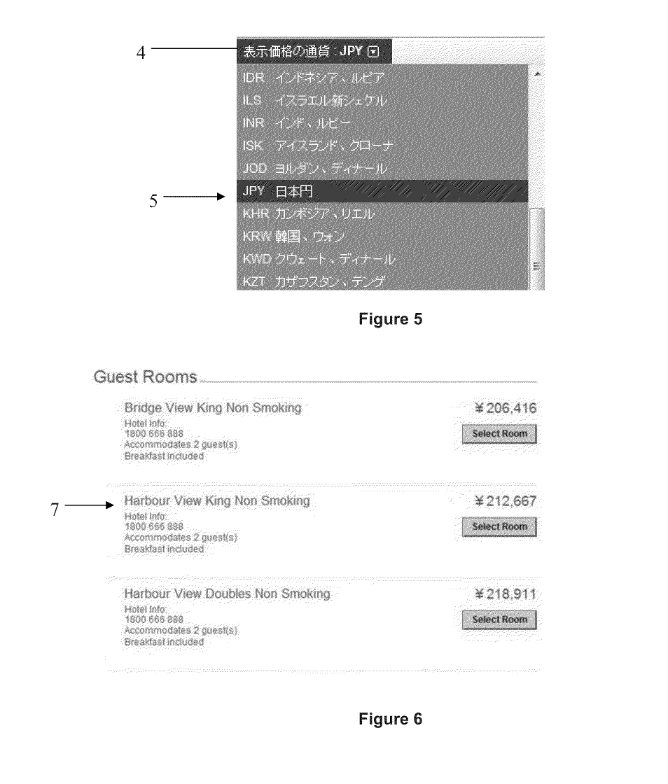

FIGS. 2, 3 and 4 for a similar session for a visitor whose first geographic location (3) is Japan will look as in FIGS. 5, 6, and 7, and they would vary likewise for other currencies. Here like integers refer to like features as described in Example 1, with the exception the first geographic location is now Japan (3), and the session currency (4) is now in yen.

The merchant default currency, let's say Singapore Dollar or SGD assuming the merchant is located in Singapore, would display in a likewise manner for clients or first computer devices (2) identified as local, Singapore in this example. In other words the default session currency (4) would be the same as the merchant currency because the two are based in the same country location.

The different parties in the process and the network (1) between them are shown in FIG. 8. The second computer device (10), for example a web server running the MCP enabled ecommerce application, needs also access to a foreign exchange (Forex) service and Location Identification Service. These are usually provided by the payment gateway (11) as shown in the FIG. 8, which in turn is connected to a forex server (12) and geographic location server (13). These may be on the same server as shown or may be on difference computer devices.

Forex rates are updated at a frequency that can vary from one application to another, in a preferred embodiment this is usually one hour. The forex rates and location service may be accessed on a per transaction basis, or bulk information may be downloaded to the payment gateway (11) and onto the MCP enabled second computer device (10), and periodically refreshed.

Once the user has completed the transaction in the selected session currency (4) the payment gateway (11) will then notify the acquiring bank (14) to debit the users account or card in the first currency and to credit or pay the merchant in the second currency.

The foregoing description of the invention includes preferred forms thereof. Modifications may be made thereto without departing from the scope of the invention.

1. A method of multi-currency pricing over a network, comprising or including the steps of:
providing information to a first computer device in a first geographic location connected to said network;
obtaining identifying data of said first computer device;
detecting said first geographic location of said first computer device from said identifying data;
choosing a first currency based on said first geographic location;
calculating an equivalent in said first currency to at least one price in said information,
wherein said information provided to said first computer device includes said price in said first currency as a default currency, which is the local currency of said first geographic location.

2. The method of claim 1 wherein said identifying data is any one or more of the following;
a. an internet protocol address;
b. latitude and longitude;
c. global Positioning System coordinates; and
d. equivalents.

3. The method of claim 1 wherein said information includes at least one product or service for sale for said price.

4. The method of claim 1 wherein said information is provided over said network from a second said computer device in at least one second said geographic location.

5. The method of claim 4 wherein said first computer device or a user thereof can override said first currency and set it to a second currency of their choosing.

6. The method of claim 5 wherein said first currency is the same as said second currency when said first geographic location and said second geographic location are the same.

7. The method of claim 5 wherein said first computer device or a user thereof purchases said at least one product or service in said first or second currency (“session currency”).

8. The method of claim 7 wherein said first computer device or user thereof is billed in said session currency for said purchase.

9. The method claim 4 wherein said second computer device enables payment of a seller or merchant of said at least one product or service in a third currency.

10. The method of claim 9 wherein said payment in said third currency is based on an equivalent to said price in said third currency.

11. The method of claim 9 wherein said third currency is based on a location of said seller or merchant or is a chosen currency of said seller or merchant.

12. The method of claim 1 wherein said step of detecting said first geographic location involves decoding, reverse coding, matching or looking up said identifying data in a database to obtain said first geographic location.

13. The method of claim 1 wherein when said identifying data is said Global Positioning System coordinates or said latitude and longitude, these are reverse geocoded to obtain said first geographic location.

14. The method of claim 1 wherein said step of choosing said first currency involves looking up the local currency of said first geographic location.

15. The method of claim 1 wherein said steps of calculating an equivalent to said price involve looking up the exchange rate for that currency.

16. (canceled)

17. (canceled)

18. A computer device, said computer device (“second computer device”) operatively connected to a network and located in a second geographic location, to carry out the following steps:
providing information to a first computer device in a first geographic location connected to said network;
obtaining identifying data of said first computer device;
detecting said first geographic location of said first computer device from said identifying data;
choosing a first currency based on said first geographic location;
calculating an equivalent in said first currency to at least one price in said information,
wherein said information provided to said first computer device includes said price in said first currency as a default currency, which is the local currency of said first geographic location.

19. A system for multi-currency pricing, adapted to run on a second computer device operatively connected to a network and located in a second geographic location, to carry out the following steps;
providing information to a first computer device in a first geographic location connected to said network;
obtaining identifying data of said first computer device;
detecting said first geographic location of said first computer device from said identifying data;
choosing a first currency based on said first geographic location;
calculating an equivalent in said first currency to at least one price in said information,
wherein said information provided to said first computer device includes said price in said first currency as a default currency, which is the local currency of said first geographic location.

20-42. (canceled)
